(19) United States
(12) Patent Application Publication
(10) Pub. No.: US 2007/0002085 A1
(43) Pub. Date: Jan. 4, 2007

(54) High availability printing systems

(75) Inventors: Meera Sampath, Chennai (IN); Shu Chang, Pittsford, NY (US); Rajinderjeet Singh Minhas, Penfield, NY (US); Bruce E. Thayer, Webster, NY (US); Gerald M. Fletcher, Pittsford, NY (US); Bryan J. Roof, Fairport, NY (US); David G. Anderson, Ontario, NY (US); Howard Mizes, Pittsford, NY (US)

Correspondence Address: Patrick R. Roche;FAY, SHARPE, FAGAN, MINNICH & McKEE, LLP, SEVENTH FLOOR, 1100 SUPERIOR AVENUE, CLEVELAND, OH, 44114-2579, US

(73) Assignee: XEROX CORPORATION

(21) Appl. No.: 11/170,845

(22) Filed: Jun. 30, 2005

(51) Int. Cl. B41J 29/38

(52) U.S. Cl. 347/5

(57) ABSTRACT

Described herein is a printing system having one or more modules for reproducing an image on a substrate; a print media source that supplies the substrate; a finisher that provides finishing capabilities for the substrate; and a controller that uses an unhealthy module with a faulty charger, developer, transferor, cleaner, fuser, etc. to partially process a job.

### BACKGROUND

The following relates to printing systems. It finds particular application to leveraging reduced capabilities provided by unhealthy components (e.g., a print engine with a faulty developer) to partially process jobs.

In a typical xerographic system, such as a copying or printing device, an electronic image is transferred to a print medium, such as paper, plastic, velum and the like. In a xerophotographic process, a photoconductive insulating member is charged to a uniform potential and exposed to a light image of an original document to be reproduced. The exposure discharges the photoconductive insulating surface in exposed or background areas and creates an electrostatic latent image on the member, which corresponds to the image areas contained within the document. Subsequently, the electrostatic latent image on the photoconductive insulating surface is made visible by developing the image with developing powder referred to in the art as toner. This image may be transferred to a support surface, such as paper, to which the toner image is permanently affixed in a fusing process.

In a multicolor electrophotographic process, successive latent images corresponding to different colors are formed on the insulating member and developed with a respective toner. Each single color toner image is transferred to the paper sheet in superimposed registration with the prior toner image. For simplex printing, only one side of a sheet is printed, while for duplex printing, both sides are printed. Other printing processes are known in which the electronic signal is reproduced as an image on a sheet by other means, such as through impact (e.g., a type system or a wire dot system), or through use of a thermosensitive system, ink jets, laser beams, or the like.

A conventional approach to increasing printing throughput is to increase the speed of the printer. However, increasing printer speed typically results in greater stress on the individual components of the printer. Another approach is to employ several marking engines, which can be vertically and/or horizontally stacked, within a printing platform. Multiple marking engine systems provide relatively higher overall output by parallel printing processes, wherein portions of the same document are printed on multiple printers or concurrently processing multiple print jobs. For example, an electronic print job that includes color and monochrome portions may be partitioned and distributed across color and monochrome printers. Print media substrate (e.g., paper, velum, plastic . . . ) is fed from a common or different source to the printers. Printed substrate is conveyed to a finisher where the media associated with a single print job are assembled. Such systems are commonly referred to as “tandem engine” printers, “parallel” printers, or “cluster printing” printers.

In a conventional single engine system, a faulty print engine typically is disabled, which shuts the system down. During periods of down time, print jobs are delayed, which results in customer annoyance, decreased customer utility, and loss in revenue. This problem is exacerbated when considered in light of a population of printing platforms. With a conventional multi-engine system, a faulty print engine typically is by-passed. Print jobs associated with the faulty print engine are re-routed to one or more non-faulty print engines. In U.S. Pat. No. 5,150,167, by Gonda, et al., and entitled “Image Forming Apparatus,” print jobs are re-routed in order to maintain continuous printing operation. However, Gonda, et al. merely determines whether a printer is able to continue processing an on-going print job based on lack of paper, low toner, etc. If not, the print job is routed to another printer that is associated with a tray with paper, a cartridge with toner, etc. In addition, simply by-passing a faulty print engine reduces processing performance and overall throughput.

### CROSS REFERENCE TO RELATED PATENTS AND APPLICATIONS

The following applications, the disclosures of each being totally incorporated herein by reference, are mentioned:

U.S. application Ser. No. 10/924,458 (Attorney Docket A3548-US-NP), filed Aug. 23, 2004, entitled “PRINT SEQUENCE SCHEDULING FOR RELIABILITY,” by Robert M. Lofthus, et al.;

U.S. application Ser. No. 11/069,020 (Attorney Docket 20040744-US-NP), filed Feb. 28, 2004, entitled “PRINTING SYSTEMS,” by Robert M. Lofthus, et al.;

U.S. application Ser. No. 11/102,899 (Attorney Docket 20041209-US-NP), filed Apr. 8, 2005, entitled “SYNCHRONIZATION IN A DISTRIBUTED SYSTEM,” by Lara S. Crawford, et al.;

U.S. application Ser. No. 11/102910 (Attorney Docket 20041210-US-NP), filed Apr. 8, 2005, entitled “COORDINATION IN A DISTRIBUTED SYSTEM,” by Lara S. Crawford, et al.;

U.S. application Ser. No. 11/102,355 (Attorney Docket 20041213-US-NP), filed Apr. 8, 2005, entitled “COMMUNICATION IN A DISTRIBUTED SYSTEM,” by Markus P. J. Fromherz, et al.;

U.S. application Ser. No. 11/102,332 (Attorney Docket 20041214-US-NP), filed Apr. 8, 2005, entitled “ON-THE-FLY STATE SYNCHRONIZATION IN A DISTRIBUTED SYSTEM,” by Haitham A. Hindi;

U.S. application Ser. No. 11/122,420 (Attorney Docket 20041149-US-NP), filed May 5, 2005, entitled “PRINTING SYSTEM AND SCHEDULING METHOD,” by Austin L. Richards;

U.S. application Ser. No. 11/136,821 (Attorney Docket 20041238-US-NP), filed May 25, 2005, entitled “AUTOMATED PROMOTION OF MONOCHROME JOBS FOR HLC PRODUCTION PRINTERS,” by David C. Robinson;

U.S. application Ser. No. 11/136,959 (Attorney Docket 20040649-US-NP), filed May 25, 2005, entitled “PRINTING SYSTEMS”, by Kristine A. German et al.;

U.S. application Ser. No. 11/137,634 (Attorney Docket 20050281-US-NP), filed May 25, 2005, entitled “PRINTING SYSTEM”, by Robert M. Lofthus et al.; and

U.S. application Ser. No. 11/137,251 (Attorney Docket 20050382-US-NP), filed May 25, 2005, entitled “SCHEDULING SYSTEM”, by Robert M. Lofthus et al.

### BRIEF DESCRIPTION

According to an aspect illustrated herein, a printing system includes one or more modules for reproducing an image on a substrate; a print media source that supplies the substrate; a finisher that provides finishing capabilities for the substrate; and a controller that uses an unhealthy module (i.e., a module lacking a normal processing function) of the printing system to partially process a job.

### BRIEF DESCRIPTION OF THE DRAWINGS

FIG. 1 illustrates an exemplary printing system that utilizes unhealthy components to process portions of jobs;

FIG. 2 illustrates an exemplary methodology for using a self-diagnosed unhealthy component of a printing system to process at least a portion of a job; and

FIG. 3 illustrates an exemplary methodology for using a component of a printing system deemed unhealthy by a user to process at least a portion of a job is illustrated.

### DETAILED DESCRIPTION

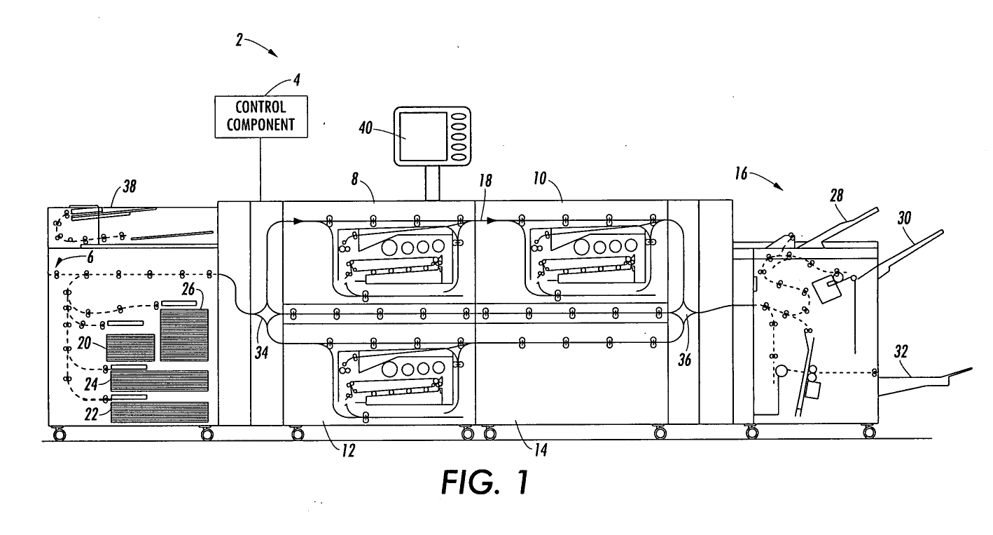

With reference to FIG. 1, a printing system 2 is illustrated. The printing system 2 includes a control component 4 that controls the components of the printing system 2 and manages print jobs. For example, the control component 4 invokes component warm-up routines when power is cycled on or when the printing system 2 transitions from a lower power (e.g., a sleep) mode to a higher power (e.g., printing) mode. In another example, the control component 2 loads software, firmware, applications and the like. In another example, the control component 2 directs print jobs to one or more print engines. In yet another example, the control component 4 monitors the health of individual components of the printing system 2. Based on the health of the components, the control component 4 continues controlling the system 2 with an executing control strategy or begins controlling the system 2 under a new control strategy. For instance, the control component 4 may deem a component (e.g., a developer, a fuser, a transferor, a charger, a cleaner . . . ) unhealthy. The control component 4 may determine that the unhealthy component is capable of performing at a reduced capacity and/or with reduced functionality. The control component 4 can accordingly adjust its control strategy to leverage the reduced set of capabilities of the unhealthy component to at least partially process jobs. It is to be understood that the foregoing examples are provided for explanatory purposes and are not all-inclusive or limitative; the control component 4 can control more, less, similar and/or different operations of the printing system 2.

The control component 4 controls a plurality of processing units 6, 8, 10, 12, 14, and 16 that are coupled through a print media conveyor 20. The processing units 6-16 cooperate to process print jobs at a relatively high rate. While this example illustrates six processing units, it is to be understood that the printing system 2 can include N processing units, where N is an integer equal to or greater than one.

One or more of the processing units 6-16 are removable. For example, the functional portion (e.g., marking engine) of the processing unit 14 is absent from the printing system 2, leaving a housing or mounting fixture through which the print media conveyor 18 passes. In this manner, the functional portion of any of the processing units 6-16 can be removed for repair or replaced to effectuate an upgrade, modification and/or repair of the printing system 2. The printing system 2 remains operational with the functional portion of the processing unit 14 removed, malfunctioning, faulty, broken, or otherwise unavailable, with some loss of the overall printing functionality.

Some or all of the processing units 8-14 may be identical to provide redundancy or improved productivity through parallel printing. Alternatively or additionally, some or all of the processing units 8-14 may be different to provide different capabilities. For example, the processing units 8 and 10 may include color marking engines, while the processing unit 12 includes a black (K) marking engine. Suitable marking engines include electrophotographic printers, ink-jet printers, including solid ink printers, thermal head printers that are used in conjunction with heat sensitive paper, and/or other devices capable of marking an image on a substrate. The marking engines may be of the same or different modalities (e.g., black (K), custom color (C), process color (P), or magnetic ink character recognition (MICR) (M)). In addition, the marking engines may be capable of generating more than one type of print modality, for example, black and process color.

In addition, the processing units 8-14 can be stacked vertically and/or horizontally to form a tandem, parallel and/or cluster printer for simplex, duplex and/or multi-pass printing. The processing units 8-14 employ xerographic printing technology, in which an electrostatic image is formed and coated with a toner material, and then transferred and fused to paper or another print medium by application of heat and pressure. However, processing units employing other printing technologies can be employed as processing units, such as processing units employing ink jet transfer, thermal impact printing, or so forth.

The control component 4 of the printing system 2 detects unhealthy components and/or is notified of such components by a user. For instance, the controller 4 can include diagnostic capabilities, which execute testing routines, fault detection schemes, and/or measure values (e.g., current, voltage, impedance, inductance, capacitance, temperature, etc.) indicative of a status or health of various components and sub components of the printing system 2. For example, the control component 4 can measure electrical current drawn by a marking engine during use. In another example, the control component 4 controls imaging sensor positioned proximate a transfer belt or drum or in connection with a path extending from a marking module. The imaging sensors collect information indicative of the print quality to detect streaks, spots, color gamut, glossiness, etc. In another example, the control component 4 can analyze sensor and/or actuator values, error logs, counters, registers, component usage, history logs, etc. to facilitate detecting unhealthy components. In other instances, a user observes less than desirable image quality (e.g., diminished gloss, streaks, spots . . . ), and the user provides the control component 4 with information regarding the image quality and/or runs diagnostics.

Upon obtaining component health status, the control component 4 determines whether the processing units 6-16, or a portion thereof, can continue processing jobs. For instance, in this example, the controller 4 may have detected a problem with the processing unit 14 or the user may have notified the control component 4 of a problem with the processing unit 14. For example, the processing unit may be faulty, malfunctioning, defective, partially operative, etc. The controller 4 may determine the problem is severe enough that the processing unit 14 had to be repaired or replaced. Alternatively, the control component 4 may have determined that the processing unit 14, although not able to fully perform, could operate at a reduced capacity. For example, an unhealthy fuser (not shown) associated with the processing unit 14 may only be able to print jobs with a relatively reduced gloss. Rather than disabling or by-passing the processing unit 14, the control component 4 can use the processing unit 14 to process jobs with less gloss requirements, wherein jobs with high gloss requirements can be re-routed to processing units with fully functioning fusers.

In another example, an unhealthy print engine (not shown) may not be able to process a color (e.g., due to a failed developer). Rather than disabling or by-passing the processing unit 14, the control component 4 can use the processing unit 14 to process jobs that do not include the color associated with the failed developer or partially process jobs that include at least one color associated with an operational developer and at least one color associated with the failed developer. In another example, a charger, a developer, a transferor, a cleaner and/or a fuser of any of the processing units 8-14 may become unhealthy such that the printing system 2 begins to reproduce images at a less than desired image quality. Such processing unit may be able to be used to process less stressful jobs such as text only jobs or jobs with relatively low area coverage without perceptible loss in image quality. For example, a printing engine that has charge deficient spots may still print text without a visible defect. Jobs requiring higher image quality, such a graphics, can be redirected to processing units with fully operational components. Other examples include unhealthy transferors, cleaners, etc. It is to be appreciated that redirecting jobs can be through various techniques such as automatic (without human assistance and/or intervention), manual (human invoked), and/or a combination thereof (e.g., where the controller determines a job should be redirected and the human initiates the redirection).

Thus, an unhealthy component may still be able to process certain jobs if those jobs do not require the unavailable features or performance levels. Therefore, whenever the fault is of a nature that renders loss of some capabilities or reduced performance, the component can still be used to process jobs that do not need theses capabilities or that will not be compromised by the reduced performance. Jobs that need the unavailable capabilities or require a higher level of performance can be re-routed to healthy components or partially processed by the unhealthy component and partially processed by a healthy component. Thus, rather than by-passing or disabling an unhealthy component of the printing system 2, as with conventional printing systems, the controller 4 determines the capabilities of the unhealthy component and leverages such capabilities to improve performance and throughput and increase availability relative to conventional systems that by-pass or disable unhealthy components.

The processing unit 6 is a print media source processing unit that supplies printing media substrate for printing, and the processing unit 16 is a finisher that provides finishing capabilities such as collation, stapling, folding, stacking, hole-punching, binding, postage stamping, or so forth. The print media source processing unit 6 includes print media sources 20, 22, 24 and 26 connected with the print media conveyor 18 to provide selected types of print media. While four print media sources are illustrated, K print media sources can be employed, wherein K is an integer equal to or greater than one. Moreover, while the illustrated print media sources 20-26 are embodied as components of the dedicated print media source processing unit 6, in other instances one or more of the marking engines may include its own dedicated print media source instead of or in addition to those of the print media source processing unit 6.

Each of the print media sources 20-26 can store sheets of the same type of print medium, or can store different types of print media. For example, the print media sources 22 and 24 may store the same type of large-size paper sheets, print media source 20 may store company letterhead paper, and the print media source 26 may store letter-size paper. The print media can be substantially any type of medium upon which one or more of the processing units 20-26 can print, such as: high quality bond paper, lower quality “copy” paper, overhead transparency sheets, high gloss paper, and so forth.

The print media conveyor 18 is controllable by the controller 4 to acquire sheets of a selected print medium from the print media sources 20-26, transfer each acquired sheet to one or more of the processing units 8-14 to perform selected marking tasks, transfer each sheet to the finisher 16 to perform finishing tasks according to a job description associated with each sheet and according to the capabilities of the finisher.

The finisher unit 16 includes one or more print media destinations 28, 30, and 32. While three destinations are illustrated, the printing system 2 can include X print media destinations, where X is an integer greater than or equal to one. The finisher unit 16 deposits each sheet after the processing in one of the print media destinations 28-32, which can include trays, pans, etc. While only one finisher is illustrated, it is contemplated that two, three, four or more finishers can be employed in the printing system 2.

The print media conveyor 18 passes through each of the processing units 8-14 to provide a bypass route in which the sheets can pass through the processing units 8-16 without interacting therewith. Branch paths are also provided in each processing unit 8-14 to take the sheet off the conveyor 18 and into the functional portion of the processing units 8-14 and to deliver the processed sheet back to the conveyor 18. In the processing unit 16, the branch paths are presently removed along with the functional portion; however, the bypass portion of the conveyor 18 remains in the processing unit 14 so as to maintain continuity of the print media conveyor 18. The conveyor 18 may also include other branch junction points, such as, for example, the branch junction points 34 and 36 to enable the conveyor to pass sheets along selected paths in the illustrated multiple-path conveyor configuration. This enables the illustrated arrangement in which the marking engine processing units 8-14 are arranged two-dimensionally. In a linear arrangement of processing units (not illustrated), the branch junction points 34 and 36 are suitably configured.

The printing system 2 executes print jobs. Print job execution involves printing selected text, line graphics, images, machine ink character recognition (MICR) notation, or so forth on front, back, or front and back sides or pages of one or more sheets of paper or other print media. In general, some sheets may be left completely blank. In general, some sheets may have mixed color and black-and-white printing. Execution of the print job may also involve collating the sheets in a certain order. Still further, the print job may include folding, stapling, punching holes into, or otherwise physically manipulating or binding the sheets. The printing, finishing, paper-handling, and other processing operations that can be executed by the printing system 2 are determined by the capabilities of the processing units 6-18 of the printing system 2. Those capabilities may increase over time due to addition of new processing units or upgrading of existing processing units. Those capabilities may also decrease over time due to failure or removal of one or more processing units, such as the illustrated removed functional portion of processing unit 14.

Print jobs can be supplied to the printing system 2 in various ways. A built-in optical scanner 38 can be used to scan a document such as book pages, a stack of printed pages, or so forth, to create a digital image of the scanned document that is reproduced by printing operations performed by the printing system 2. Alternatively, a print job can be electronically delivered to a system controller (not shown) via a wire or wireless connection by a remote device such as another print platform, a computer, etc. For example, a network user operating word processing software running on a remote computer may select to print the word processing document on the printing system 2, thus generating a print job, or an external scanner (not shown) connected to the network may provide the print job in electronic form. It is also contemplated to deliver print jobs to the printing system 2 in other ways, such as via CD, DVD, optical disk, magnetic tape, flash memory, etc., or using a dedicated computer connected only to the printing system 2.

An interface 40 provides a mechanism for interaction between the printing system 2 and a user. The interface 40 displays various menus and enables the user to configure the printing system 2 and/or print jobs. The user interacts with the user interface 40 to navigate through menus, select options, configure the printing system 2, activate a particular function in connection with a multi-functional platform (e.g., print, copy, scan . . . ), retrieve messages, etc. By way of example, a user desiring to produce several copies of a document can interact with the user interface 40 to activate a copy menu, input a number of copies, define paper type (e.g., letter, A4 . . . ), set print quality (e.g., resolution) and color (e.g., grey scale, color . . . ), etc. This information is provided to the control component 4, which executes instructions to produce the copies based on the user input. As described previously, the control component 4 also controls various other aspects of the printing system 2 such as warm up routines, transitions into and out of low power inactivity modes, loading software, firmware and applications, routing print jobs to the processing units 8-14, etc.

The printing system 2 is illustrative. In general, any number of print media sources, media handlers, marking engines, collators, finishers or other processing units can be connected together by a suitable print media conveyor configuration. While the printing system 2 illustrates a 2×2 configuration of four marking engine processing units 8-14, buttressed by the media source unit 6 on one end and by the finisher unit 16 on the other end, other physical layouts can be used, such as an entirely horizontal arrangement, stacking of processing units three or more units high, or so forth. Moreover, while in the printing system 2 the marking engine processing units 8-14 have removable functional portions, in some other embodiments some or all processing units may have non-removable functional portions and/or field replaceable units. It will be appreciated that even if the functional portion is non-removable, the provision of the print media conveyor 18 with bypass paths through each intermediate processing unit enables the processing unit to be taken “off-line” for repair or modification while the remaining processing units of the printing system continue to function as usual.

In some aspects, separate bypasses for intermediate components may be omitted. The “bypass path” of the conveyor in such configurations suitably passes through the functional portion of a processing unit, and optional bypassing of the processing unit is effectuated by conveying the sheet through the functional portion without performing any processing operations. Still further, in some aspects the printing system may be a cluster of networked or otherwise logically interconnected printers each having its own associated print media source and finishing components.

The plurality of processing units 6-16 and flexible print media conveyor 18 enables the printing system 2 to have a large number of capabilities and features. Each marking engine 8-14, for example, has associated low-level print settings such as xerographic voltages, fuser temperatures, toner reproduction curves, and so forth. Some of these low-level print settings are optionally modified depending upon the sequence along which a given sheet passes through the printing system 2; for example, it may be advantageous to modify the fusing temperatures of serially performed xerographic processes. At a higher functional level, each marking engine has associated functional parameters such as contrast, resolution, and so forth.

Typically, the user has certain user preferences regarding performance of the printing system 2. The user ideally wants a highly efficient or productive printing (that is, a high throughput of sheets and print jobs through the printing system 2), high printing quality, image quality consistency across each print job, and so forth. At the same time, the user typically wants the printing system 2 to maintain high reliability (that is, minimize the down-time of the printing system 2), low run cost (achieved, for example, by minimizing cycling of processing units between idle and active states), low service costs (achieved, for example, by distributing usage of consumable elements across similar processing units), high energy efficiency, and so forth.

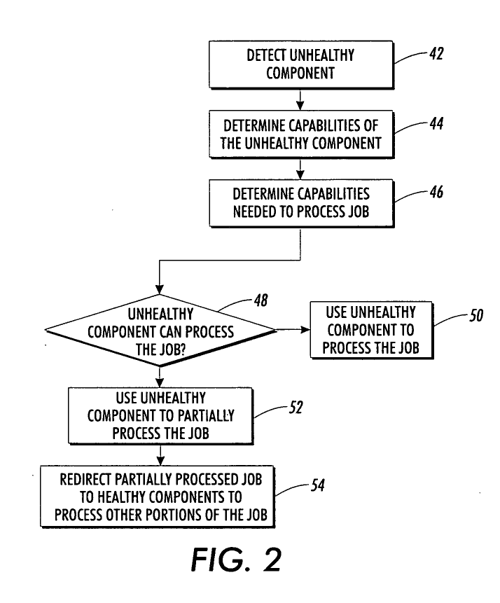

With reference to FIG. 2, a methodology for detecting and using an unhealthy component of a printing system to process at least a portion of a job is illustrated. At reference numeral 42, the unhealthy component is detected. Such detection can be through self-diagnostics and/or fault detection schemes. For instance, a controller of the printing system may invoke diagnostics (e.g., application software residing in local storage) that execute testing routines and/or measure characteristics such as current, voltage, impedance, inductance, capacitance, temperature, etc. The results from such testing and/or measured values can indicate a health of various components of the printing system. For example, the controller can measure electrical current drawn by a marking engine during use, and the measured value can be compared with a predefined acceptable range. If the measured electrical current value is outside of the predefined acceptable range, the controller deems the marking engine as unhealthy. In another example, the controller controls imaging sensors positioned proximate a transfer belt or drum or in connection with a path extending from a marking module. The imaging sensors collect information indicative of the print quality to detect streaks, spots, color gamut, glossiness, etc. Likewise, if a sensed print quality value is outside of a predefined acceptable range, then the corresponding component is deemed unhealthy. In another example, the controller analyzes error logs, history logs, component usage, sensor values, actuator values, registers, counters, etc. to facilitate determining whether a component is unhealthy.

At reference numeral 44, the capabilities of the unhealthy component are determined. For instance, the controller may determine that one of the colors of a four color printing engine is no longer available; and, thus, the other three colors are still available. In another instance, the controller may determine that a fuser may only be able to print jobs with a relatively reduced gloss. In still other instances, the unhealthy component can be a charger, a cleaner, a transferor, etc. Regardless of the component, it may be able to process jobs that do not require the unavailable features or performance levels. Therefore, whenever the fault is of a nature that renders loss of some capabilities or reduced performance, the component can still be used to process jobs that do not need these capabilities or that will not be compromised by the reduced performance. At 46, the capabilities needed to process a job are determined. For instance, the job may include one, two, three, or all four of the colors. If the job includes less then four colors, the controller determines whether the unhealthy component is associated with processing the job.

At 48, if it is determined that the processing unit associated with the unhealthy component can process the job, then, at 50, the processing unit processes the job. For example, if the unhealthy component is a developer associated with the color cyan and the job does not include the color cyan, then the processing unit can fully process the job with its reduced capabilities. Thus, rather than being deemed inoperable and not being used to process jobs, the printing engine can process jobs that only require available colors.

If at 48 it is determined that the processing unit associated with the unhealthy component cannot fully process the job, then, at 52, the processing unit partially processes the job. For example, three of the four colors can be processed by the unhealthy printing engine and the fourth color can be marked by another printing engine. In another instance, the unhealthy printing engine can process jobs where the reduced gloss is acceptable or process a job except for fusing the reproduced image, which can be done by another printing engine. Thus, instead of redirecting an entire job to another printing engine, the unhealthy printing engine is used to partially process the part of the job that it is capable of processing. At reference numeral 54, the job is directed to another processing unit for further processing.

It is to be appreciated that the order of the above processing acts and the processing acts are not limited by this example. For instance, in another embodiment, after the job is partially processed by the unhealthy component at 52, it is redirected to another processing unit at 54, which partially process the job, and then the job is directed back to the unhealthy component at 52 for further partial processing. It is to be understood that the job can be redirected to other processing units for partial processing and back to the unhealthy processing unit for partial processing any number of times, for example, until the job is completed or terminated. In addition, if at 48 it is determined that the processing unit associated with the unhealthy component cannot fully process the job, the job can be first re-directed to one or more other processing units for partial processing at 54 and then returned to the unhealthy component for further partial processing at 52. Again, the number of times the job is redirected to another processing unit and directed back to the unhealthy processing unit is not limited.

Thus, rather than by-passing or disabling an unhealthy component of a printing system, as with conventional printing systems, the capabilities of the unhealthy component are leveraged to improve performance and throughput and increase availability relative to conventional systems that by-pass or disable unhealthy components. Jobs that need unavailable capabilities or require a higher level of performance can be re-routed to healthy components.

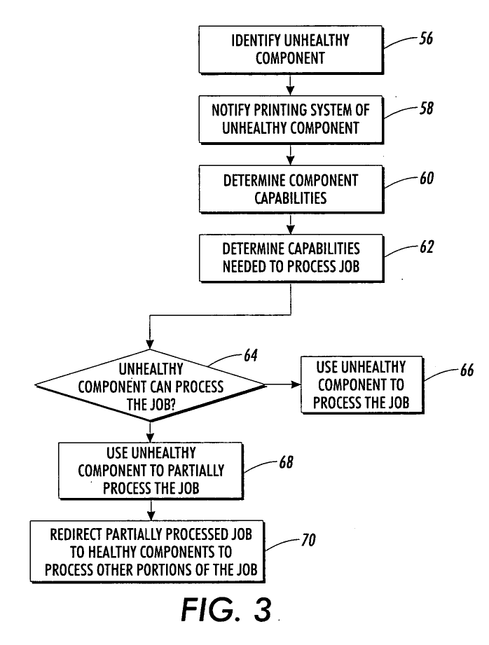

With reference to FIG. 3, a methodology for using a component of a printing system deemed unhealthy by a user to process at least a portion of a job is illustrated. At 56, the user identifies a component as unhealthy, failing, malfunctioning, etc. For example, the user may notice reduced output image quality imaging such as streaks, spots, color gamut, glossiness, etc. At 58, the user notifies the printing system of such reduction in image quality, for example, through entering information through a user interface or conveying information through a port (e.g., wire/wireless network, serial, infrared (IR) . . . ).

At reference numeral 60, the printing system analyzes the identified component to determine available capabilities. As described above, the controller may determine that one of the colors of a four color printing engine is no longer available; and, thus, the other three colors are available. In another instance, the controller may determine that a fuser may only be able to print jobs with a relatively reduced gloss. If the printing system determines the component is fully functional, the user can accept this decision or manually deem the component as unhealthy. At 62, the features required to process a job are determined. For instance, does the job include one, two, three, or all four of the colors, and if less then four colors are required, does the job include the unavailable color.

At 64, if it is determined that the processing unit associated with the unhealthy component can process the job, then, at 66, the processing unit processes the job. For example, if the unhealthy component is a developer associated with the color cyan and the job does not include the color cyan, then the processing unit can fully process the job with its reduced capabilities. Thus, rather than being deemed inoperable and not being used to process jobs, the printing engine can process jobs that only require available colors. If at 64 it is determined that the processing unit associated with the unhealthy component cannot fully process the job, then, at 68, the processing unit partially processes the job. For example, three of the four colors can be processed by the unhealthy printing engine and the fourth color can be marked by another printing engine. In another instance, the unhealthy printing engine can process jobs where the reduced gloss is acceptable or process a job except for fusing the reproduced image, which can be done by another printing engine. Thus, instead of redirecting an entire job to another printing engine, the unhealthy printing engine is used to process the portion of the job that it is capable of processing. At reference numeral 70, the job is directed to another processing unit to finish processing the job.

It is to be appreciated that the order of the above processing acts and the processing acts are not limited by this example. For instance, in another embodiment, after the job is partially processed by the unhealthy component at 68, it is redirected to another processing unit at 70, which partially process the job, and then the job is directed back to the unhealthy component at 68 for further partial processing. It is to be understood that the job can be redirected to other processing units for partial processing and back to the unhealthy processing unit for partial processing any number of times, for example, until the job is completed or terminated. In addition, if at 64 it is determined that the processing unit associated with the unhealthy component cannot fully process the job, the job can be first re-directed to one or more other processing units for partial processing at 70 and then returned to the unhealthy component for further partial processing at 68. Again, the number of times the job is redirected to another processing unit and directed back to the unhealthy processing unit is not limited.

### EXAMPLES

The following provides several examples describing suitable use of an unhealthy print engine in a printing system. These examples are provided for explanatory purposes and are not limitative. It is to be understood that the printing system can include any number of print engines. In this system, the system engine is represented by an aggregate of the individual print engines. In a conventional system, when one of the print engines becomes unhealthy, it typically is by-passed. Consequently, overall engine performance (e.g., throughput) decreases.

A first set of examples illustrates suitable use of an unhealthy print engine(s) in a two-parallel, color print engine system. This set of examples assumes one or more developers associated with one or more print engines have failed and are inoperable.

In one instance, a developer of one of the color print engines fails; and, thus, the associated print engine is deemed unhealthy. The developer can be associated with any color, for example, black, cyan, yellow or magenta. With conventional print systems, the unhealthy print engine would be by-passed. In a two-parallel, color print system, by-passing one of the print engines would lead to a fifty percent reduction in throughput. As described herein, the subject printing system leverages available capabilities of an unhealthy component rather than by-passing the unhealthy component. In this particular instance, jobs that do not include the unavailable color can still be delivered to and processed by the unhealthy engine. Jobs that include the unavailable color and at least one other available color can be partially processed by the unhealthy print engine. Remaining colors can be processed by the healthy color print engine. The healthy print engine also continues to process for color jobs.

For example, assume a developer associated with the color cyan is inoperable. The unhealthy print engine can still process one or more colors other than cyan. A healthy print engine can be used to process other colors, including cyan. Thus, the unhealthy print engine can partially process the job, and the job can be routed to the healthy color print engine for partial processing of at least the color cyan. Alternatively, the healthy color print engine can partially process the job, including the color cyan, and the job can be routed to the unhealthy color print engine for partial processing of at least one color other than cyan. Typically, the image is fused after partial processing by one print engine and before partial processing by the other print engine.

Thus, rather than by-passing the unhealthy engine like conventional printing systems, the unhealthy engine is used to process images that do not include the unavailable color or partially process images that include the unavailable color and at least one other color. The foregoing provides increased printing system availability and throughput over conventional systems.

In another instance, a developer associated with each color print engine fails, and both print engines are deemed unhealthy. It is assumed in this case that the developers are associated with different colors. As noted above, with conventional print systems unhealthy print engines are by-passed, which, in this case, would shut down the printing system. Instead, the partial functionality of the unhealthy color print engines is leveraged to process jobs that include colors associated with operating developers. Thus, each print engine can process jobs that only include colors corresponding to operating developers, and each print engine can partially process jobs that include at least one color corresponding to an operating developer and at least one color corresponding to an inoperable developer.

Where the failed developers are associated with different colors, the two color print engines can be used in combination to process the four colors, wherein each color print engine processes at least one color not available to the other color print engine. For example, one color print engine would partially process the job with available developers, and the other color print engine would partially process the job with its available developers. Such processing can be used for serial job processing, wherein one color print engine partially processes a job and then the other color print engine partially processes the job, or parallel job processing, wherein each print engine concurrently partially processes a job, the jobs are switched, and each color print engine concurrently partially processes remaining portions of the job.

Where both print engines include failed developers for a similar color, for example, neither print engine can process the color cyan, the unhealthy print engines still can partially process, alone or in combination, jobs that do not include the color cyan. For example, each color print system can process jobs the include black, magenta, and/or yellow. Therefore, rather than shutting down the system by shutting down the two unhealthy print engines like conventional printing systems, the two unhealthy print engines are used to process jobs only including colors associated with operating developers and/or process jobs that include four colors by processing the jobs in combination, including serial and/or parallel job processing. The foregoing provide for increased availability and throughput over conventional systems.

Another set of examples illustrates suitable use of an unhealthy print engine(s) in a two-parallel, black and color print engine system. With this system, the black engines process black and white jobs and the color engines process color and/or highlight color. One path includes a black print engine and a color print engine, and a parallel path includes another black print engine and another color print engine. For sake of brevity, a two path system is described. However, the system can include any number of paths with any number of black and/or color print engines. This set of examples also assumes one or more developers associated with one or more print engines has failed and is inoperable. With conventional print systems, the unhealthy print engines would be by-passed, resulting in reduced print engine availability and throughput. The aspects described herein leverage capabilities of unhealthy print engines, rather than shutting them down, to provide increased print engine availability and throughput relative to conventional systems.

In the instance where the cyan, magenta and/or yellow developers associated with of one of the color print engines fails, the path associated with the unhealthy developer can be used to process black and white jobs and jobs only including available colors, and partially process jobs that include at least one available color and one unavailable color. Thus, rather than by-passing the corresponding path, the unhealthy print engine can process jobs that include only available colors or partially process jobs that include at least one available color, wherein the print engines associated with the other path processes the other colors. For instance, if the developer associated with the color cyan in the color print engine of one path fails, this path can be used to process black and white jobs with either the black print engine or the color print engine and color jobs that do not include the color cyan, or partially process jobs that include cyan and at least one other color.

In order to balance processing load across paths, black and white jobs can be redistributed such that the path with the failed color developer(s) processes more black and white jobs since the color print engine in the other path will be processing more color jobs.

In the instance where one of the black print engines or the developer associated with the color black of one of the color print engines fails, the path associated with the unhealthy developer can be used to process jobs since there is a redundant black developer in each path. If both the black print engine and the developer associated with the color black of the color print engine fail in the same path, the unhealthy print engine can process jobs that include colors other than black or partially process jobs that include at least one available color and the color black.

Other embodiments include facilitating processing jobs when components other than print engines are unhealthy and/or unavailable. Likewise, these examples are provided for explanatory purposes and are not limitative. In one instance, if a media source is empty or otherwise unavailable, a job can be redirected to an alternate media source. In another instance, when print quality defects occur at one side of the image in long-edge printing, or any other problem develops in long edge printing, the job can be redirected to an alternate tray with short edge feeding and/or the paper may be automatically rotated to short edge feed to avoid the defect. In another instance, an unhealthy IOT may still be able to print simplex. Thus, simplex job can be processed by the unhealthy IOT and duplex jobs can be redirected to one or more alternate IOTs. Simplex jobs associated with the alternate IOTs can be redistributed to the unhealthy IOT in order to balance job load across IOTs.

It will be appreciated that various of the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims.

The claims can encompass embodiments in hardware, software, or a combination thereof.

The term “printer,” “print,” and variations thereof as used herein encompass any apparatus, such as a digital copier, bookmaking machine, facsimile machine, multi-function machine, etc. which performs a print outputting function for any purpose.

1. A printing system, comprising:
a source that provides a print media substrate;
one or more modules for reproducing an image on the print media substrate;
a controller that uses an unhealthy module with reduced capabilities relative to a healthy module to at least partially process a job; and
a finisher that finishes the image on the print media substrate.

2. The printing system of claim 1, wherein the unhealthy module includes one or more of a faulty charger, a faulty developer, a faulty transferor, a faulty cleaner and a faulty fuser.

3. The printing system of claim 1, wherein the controller redirects one of an unprocessed job and the partially processed job from the unhealthy module to one of a healthy module and another unhealthy module, with suitable capabilities, to process unprocessed portions of the job.

4. The printing system of 3, wherein the job is redirected with human intervention, without human intervention, or a combination thereof.

5. The printing system of claim 1, wherein the controller uses the unhealthy module to process a job that only requires capabilities available to the unhealthy module.

6. The printing system of claim 1, wherein the controller executes diagnostics to identify the unhealthy module.

7. The printing system of claim 1, wherein the controller determines the capabilities of the unhealthy module.

8. The printing system of claim 1, wherein the controller determines a health of a component of the unhealthy module from at least one of an associated electrical characteristic including at least one of a current, a voltage, an impedance, an inductance, a frequency, and a capacitance, user input, data logs and counters including at least one of faults, exceptions, part usage, and service history.

9. The printing system of claim 1, wherein the controller determines a health of a component of the unhealthy module from an associated print quality characteristic including at least one of a streak, a spot, color gamut, and glossiness, the controller obtains the associated print quality characteristic through at least one of self-diagnostics and user input.

10. The printing system of claim 1, wherein the one or more modules includes marking modules that are stacked one of vertically, horizontally, and vertically and horizontally to form one of a tandem, a parallel and a cluster printer.

11. The printing system of claim 1, wherein the one or more modules include one or more of an electrophotographic printer, an ink-jet printer, a solid ink printer, and a thermal head printer.

12. The printing system of claim 1, wherein the one or more modules include one or more of a black, a custom color, a process color, a highlight color, and a magnetic ink character recognition marking engine.

13. The system of claim 1, wherein the system is a xerographic apparatus.

14. A method for using an unhealthy component of a printing system to partially process a job, comprising:
determining one or more capabilities of a component that is unhealthy, the one or more capabilities represents diminished capabilities relative to the capabilities available when the component is healthy; and
using the diminished capabilities of the unhealthy component to at least partially process the job.

15. The method of claim 14, further including determining the unhealthy component is one or more of a faulty charger, a faulty developer, a faulty transferor, a faulty cleaner and a faulty fuser.

16. The method of claim 14, further including redirecting the partially processed job to a substantially similar component to finish processing the job.

17. The printing system of claim 14, further including using the diminished capabilities of the unhealthy component to fully process jobs that only require capabilities available to the unhealthy component.

18. The method of claim 14, further including identifying the unhealthy component through at least one of self diagnostics and user input.

19. A xerographic process for using an unhealthy component of a printing system to partially process a job, comprising:
determining the capabilities of the unhealthy component; and
using the unhealthy component to partially process the job.

20. The method of claim 19, wherein the unhealthy component includes one or more of a faulty charger, a faulty developer, a faulty transferor, a faulty cleaner and a faulty fuser.
